(19) United States
(12) Patent Application Publication
(10) Pub. No.: US 2026/0358055 A1
(43) Pub. Date: Nov. 12, 2026

(54) HEAT TREATMENT AND ARTICLE CONVEYING SYSTEMS AND METHODS

(71) Applicant: Consolidated Engineering Company, Inc., Kennesaw, GA (US)

(72) Inventors: Scott P. Crafton, Marietta, GA (US); Piotr Mikhailovich Khramov, Power Springs, GA (US); Patrick Gaunt, Kennesaw, GA (US)

(21) Appl. No.: 19/649,334

(22) Filed: Apr. 16, 2026

Related U.S. Application Data
(60) Provisional application No. 63/800,735, filed on May 6, 2025.

(51) Int. Cl. F27B 9/24; B65G 13/04; B65G 47/244; C21D 9/00; F27B 9/40; F27D 3/00

(52) U.S. Cl. CPC F27B 9/2407; B65G 13/04; B65G 47/2445; C21D 9/0012; F27B 9/40; F27D 3/00; B65G 2201/0217; B65G 2203/0233; B65G 2811/095; F27D 2003/0043

(57) ABSTRACT

Systems and methods for conveying an article through one or more treatment chambers are disclosed and comprise a conveying system extending through the one or more chambers for moving an article along a treatment path therethrough. The conveying system includes a series of roller assemblies, each including a roller having a receptacle configured to receive the article, and a motor configured to rotate the roller in a first direction for moving the article along the path through the chamber and a second direction opposite the first direction. As the article is moved along the treatment path, the rollers of selected roller assemblies may be driven in the second direction for a time sufficient to disrupt frictional contact or change one or more of a magnitude and/or a direction of a frictional force between a portion of the article and the rollers to maintain an alignment of the article.

### CROSS REFERENCE

This application claims benefit of U.S. Provisional Patent Application No. 63/800,735, filed May 6, 2025.

### INCORPORATION BY REFERENCE

The disclosure and figures of U.S. Provisional Patent Application No. 63/800,735, filed May 6, 2025, are incorporated by reference herein for all purposes as if set forth in its entirety.

### TECHNOLOGICAL FIELD

Example embodiments of the present disclosure relate generally to systems and methods for heat treatment of articles, and more particularly, to systems and methods for aligning an article and maintaining the alignment of the article as the article is conveyed along a path of travel through one or more chambers and/or transition spaces of a heat treatment system and/or as part of a method of heat treatment.

### BACKGROUND

Furnaces or heat treatment chambers are used to heat articles to an elevated temperature to enhance strength and lengthen the life of the object or article and to provide the article with a particular desired characteristics that can be developed through heat treatment. In addition, the heat-treated articles may further pass or travel through other treatment chambers, such as a quenching chamber, aging chamber, and/or transition spaces therebetween, to apply subject the articles to treatments.

For articles of a cylindrical or tubular shape, furnaces have included a plurality of hourglass/butterfly rollers extending along a path of travel through the treatment chambers to support the article and move the article from the inlet to the outlet of each chamber. As the cylindrical or tubular article are driven forwardly by the rollers, the articles can have a tendency to ride or creep up along the side walls of the hourglass/butterfly rollers, causing the article to misalign, which can create warping and other damaging effects. The tendency of the cylindrical or tubular articles to misalign can be further increased where, for example, the article has a rough or textured surface that may generate additional friction against a roller and/or is of a size and/or shape that may cause one end of the article to begin to move to one side of the rollers, while the other end of the article moves to the other side of the rollers. In addition, if the article is not realigned, the article may fall off one or more of the rollers, and since such articles can have a substantial weight (for example, hundreds or thousands of pounds), this can damage the article such that it has to be recycled. Still further, the article also can be substantially high in temperature (for example, reaching several hundreds of degrees Fahrenheit during heat treatment), such that if an article falls off a roller, the article typically must remain in such a position until its temperature has dropped to within a range to allow it to be moved. Even after sufficient cooling, moving the article still can present difficulties due to the weight of the article and position of the article, including any portion remaining on the rollers.

Accordingly, it can be seen that a need exists for systems and methods of conveying or transporting articles through chambers such as for heat treatment and/or other treatments, which are directed to addressing the foregoing and other related and unrelated problems in the art.

### BRIEF SUMMARY

Briefly described, the present disclosure is directed to systems and methods for treating articles, including various operations such as heat treatment, quenching, aging, and other treatment operations, including conveying systems, control systems, and related methods that enable a substantially automatic correction of the alignment of articles being conveyed along a path of travel through one or more treatment chambers and/or areas between such treatment chambers, such as, in embodiments, conveying the articles along a treatment path extending through one or more different chambers of a heat treatment system of facility, including heat treatment, aging, quenching and other chambers or areas, to facilitate the consistent heat treatment, quenching, aging and other treatments of articles, including substantially circular and irregularly shaped articles.

For example, in embodiments, the conveying system is adapted for moving substantially cylindrical or curved articles such as bars/tubes/barrels, and other generally cylindrical articles, which articles also can, in some embodiments, include tapered, solid and/or hollow articles. The articles also may include various surface features, including smooth, rough, or textured surfaces. In addition, the articles can further include any exterior features such as steps, dents or deformities along the surface thereof.

Briefly described, the systems and methods described herein include embodiments of heat treatment systems including a conveying system configured to transport articles along a treatment path of travel for heat treatment, aging, quenching, and/or other treatment operations. In embodiments, the conveying system will be adapted to selectively operate (e.g., reverse, stop or otherwise vary the rotation thereof) individual rollers or similar driving members of the conveying system moving the article along its path of travel sufficient to substantially disrupt the friction creating a frictional engagement of contact between the article and the rollers or change one or more of a magnitude and/or direction of the friction force between the article and the rollers of the conveying systems to correct alignment issues due to the article (e.g., a round or substantially cylindrical bar or tube) creeping upwardly, without impeding current heat treatment processes.

For example, in various embodiments, the conveying system may include a plurality of roller assemblies, each of which can include a roller having a motor coupled thereto, with, in some embodiments, a receptacle being formed or defined in each roller and which can be generally configured as a substantially V-shaped groove or recess; and a controller configured to control operation of the motors. In embodiments, the motor of each roller of the conveying system may drive/rotate its roller independently from each other roller and further may include a variable speed and/or bi-directional motor operable to drive its roller in opposite, first and second directions. In embodiments, the direction of rotation of one or more of the rollers in contact with the article may be controlled (e.g., reversed) so as to substantially disrupt frictional contact or change one or more of a magnitude or direction of a frictional force between the rollers and the article, sufficient to cause the article to move or fall back into the V-shaped grooves or recesses of the conveying system to maintain alignment of the article along a longitudinal central axis of the conveying system.

In embodiments, the reversal of the rollers can be conducted on a patterned or sequential basis, and/or at selected times; in addition or as an alternative, in some embodiments, sensors also can be provided to monitor a position of the article within the receptacles, and if a mis-alignment of the article is detected, the controller can selectively reverse the direction of rotation of one or more rollers of the conveying system. Such a reversal of the direction of a roller may occur for a brief period of time or for a brief duration (for example, seconds or minutes) sufficient to change one or more of the magnitude or direction of the frictional force between the article and the sides of the V-shaped grooves or recesses of the rollers and enable the article to move back to a centered, aligned position, without affecting (substantially increasing/or decreasing) the residence time of the article in a particular chamber.

Thus, misalignment of the article may be corrected with limited to substantially no user input being required. Such a correction will save time and reduce cost, since the extended period to wait for an article to cool will not be needed, as the article will not move off the rollers due to misalignment. In other words, while some misalignment may occur, the conveying system will be configured to prevent substantial misalignment, keeping the article in a straight orientation/alignment and reducing deflection of the article between the ends thereof, and the potential for the article to move off-track or fall out of the receptacles of the roller assemblies. Further, such conveying systems and methods can help substantially prevent deformation of an article due to extended misalignment.

Accordingly, various aspects of the present disclosure are directed to systems and methods for treatment of various types and/or configurations of articles, and, in embodiments, will a conveying system configured to transport or convey such articles. According to some aspects, the system may comprise a treatment system including one or more treatment chambers, and, in some embodiments, one or more transition spaces. The treatment system further may comprise at least one conveying system extending through one or more of the chambers, and, in embodiments through one or more transition spaces between the chambers, and which generally is configured for conveying an article to be treated along a path of travel through the chamber(s).

In embodiments, the at least one conveying system may comprise a plurality of roller assemblies. Each of the plurality of roller assemblies may include a roller, a receptacle positioned or defined along the roller and configured to receive the article therein as the article is conveyed along the path of travel, and at least one motor coupled to the roller and configured to rotate the roller in a first direction for moving the article along the path of travel through the chamber, and a second direction that is opposite the first direction. As the article is moved along the path of travel through the chamber, one or more selected rollers of one or more of the plurality of roller assemblies may be driven in the second direction (or in some embodiments stopped) for a time sufficient to change one or more of a magnitude or direction of frictional force of at least a portion of the article and the one or more selected rollers so as to substantially maintain an alignment of the article within the receptacles of the roller assemblies.

In embodiments, the treatment system may comprise at least one controller in communication with the plurality of roller assembles, and which, in embodiments, can include programming (e.g., a computer program product or application) configured to operate the motors of a series of the roller assemblies to drive the rollers thereof in the first direction at a speed and for a selected duration to cause the article to be moved along the path of travel, and to selectively operate one or more motors to drive the one or more selected rollers in the second direction.

In embodiments, the at least one controller may further comprise programming configured to operate one or more motors of the plurality of roller assemblies to cause the one or more selected rollers to be driven at a different speed and for a duration less than the selected duration, and/or to drive the one or more selected rollers in the second direction to thereby substantially disrupt the frictional contact or change one or more of the magnitude or direction of frictional force created between the article and angled surfaces of the receptacles of the roller assemblies sufficient to cause the article to be moved toward a re-aligned position within the receptacles of the roller assemblies. In addition, in some embodiments, the conveying system can include a controller or can be linked to the system controller for the treatment system, or to a facility control system; and in other embodiments, each motor can include a motor controller linked to the controller of the conveying system, or to the system controller.

According to another aspect, each roller assembly further may include a controller coupled to the motor and configured to control operation of the motor independently of the motor of each other roller assembly. Each controller may include programming configured to operate its motor to drive the roller in the first direction for a first selected time period, and after the first selected time, drive the roller in the second direction for a second selected time period; and wherein the second selected time period is less than the first selected time period. Each controller may be further configured to operate its motor so as to drive the roller in the first direction at a first speed, and drive the roller in the second direction at a second speed that is different from the first speed so as to disrupt the frictional contact or change one or more of a magnitude or direction of frictional force between the article and rollers of the plurality of roller assemblies and cause the article to re-align within the receptacles of the roller assemblies.

In another aspect, the chamber may comprise one or more of a furnace, an air quench, a water quench, an oven, or a transition space or area.

In another aspect, the article may comprise a bar having a substantially solid or hollow construction. In embodiments, the bar may further comprise an exterior wall and the exterior wall may comprise a substantially smooth surface, a textured or rough surface, at least one surface feature, a substantially uniform circumference, a non-uniform circumference, or combinations thereof.

In another aspect, each receptacle may include a body having a first angled surface and a second body section having a second angled surface defining a substantially V-shaped recess configured to receive the article therein. In some embodiments, the first surface and the second surface of one or more of the receptacles may extend upwardly from a central portion of the body of the roller at an angle of between approximately 5° to approximately 30°.

In another aspect, the roller of each of the roller assemblies may be arranged at an angle of between approximately 0° to approximately 20° with respect to a longitudinal central axis of the at least one conveying system.

In another aspect, each motor may comprise a variable speed drive motor or a variable frequency drive motor.

In another aspect, each roller may comprise an hourglass roller including a pair of opposed angled surfaces defining the receptacles.

In another example, the roller assemblies may each comprise a temperature rating of up to 2400^{o} Fahrenheit.

Other aspects and embodiments of the disclosure are directed to a conveying system. In embodiments, the conveying system may include a plurality of roller assemblies each including a roller, a receptacle positioned along the roller and configured to receive an article therein as the article is conveyed along a path of travel, and at least one motor coupled to the roller and configured to rotate the roller in a first direction for moving the article along the path of travel, and a second direction that is opposite the first direction. As the article is moved along the path of travel, one or more selected rollers of one or more roller assemblies may be driven in the second direction for a selected time sufficient to disrupt a frictional contact between the rollers and the article or change one or more of a magnitude or direction of frictional force between at least a portion of the article and the one or more selected rollers so as to substantially maintain an alignment of the article within the receptacles of the roller assemblies.

In another aspect, the conveying system may further comprise a sensor configured to detect misalignment of the article and at least one motor configured to drive one or more corresponding selected rollers of one or more of the plurality of roller assemblies in the second direction for the selected time.

In another aspect, the conveying system may comprise a controller in communication with the plurality of roller assemblies and comprising a processor and a memory, the memory configured to store instructions, that when executed by the processor, can direct/control the motors of a series of the roller assemblies to drive the rollers in the first direction at a first speed so as to cause the article to be moved along the path of travel, and to selectively operate one or more motors of the one or more of the roller assemblies to drive the one or more selected rollers in the second direction for the selected time. In embodiments, each receptacle may comprise a pair of opposite angled surfaces defining a substantially V-shaped recess configured to receive the article therein; and wherein the at least one controller further includes instructions stored in the memory, the instructions, when executed by the processor, being adapted to cause one or more motors to drive the one or more selected rollers linked thereto in the second direction at a second speed that is different from the first speed sufficient to disrupt a frictional contact created between the article and the surfaces of the receptacles or to change one or more of a magnitude or direction of a frictional force between the article and one or more surfaces of one or more of the receptacles of the roller assemblies sufficient to enable the article to be move toward a re-aligned position substantially centered within the receptacles of the roller assemblies.

In some embodiments, the controller can include programming (e.g., a computer program product or application) that includes the instructions for controlling the motors and further can include instructions for communication with one or more controllers for one or more roller assemblies, and/or with a facility control system.

In another aspect, the conveying system may extend through one or more of a furnace, an air quench, a water quench, an oven, or a transition space or area.

In another aspect, the article may comprise an article having a substantially solid or hollow construction; and in some embodiments, the article can include a substantially smooth surface, a textured or rough surface, at least one surface feature, a substantially uniform circumference, a non-uniform circumference, or combinations thereof.

Another embodiment of the disclosure is directed to a method to convey an article. The method may include receiving an article along a conveying system. The conveying system may comprise a plurality of roller assemblies each including at least one roller having a receptacle located therealong and within which a portion of the article is received. The method may include, with the article received within the receptacles of the plurality roller assemblies, rotating the rollers of a subset of roller assemblies of the plurality of roller assemblies in a first direction at a first selected speed to cause the article to be moved along a path of travel in the first direction. In embodiments, the method further may include, as the article is moved along the path of travel by the roller assemblies, selectively rotating one or more rollers of one or more selected roller assemblies in a second direction for a selected time sufficient to disrupt one or more areas of frictional contact or change one or more of a magnitude or direction of frictional force between the article and one or more rollers of the plurality of roller assemblies so as to cause the article to move toward a re-aligned position with respect to a longitudinal axis extending along the conveying system.

In an aspect, the method may include selectively rotating the one or more rollers of the one or more selected roller assemblies in the second direction comprises sequentially rotating the rollers of successive ones of the roller assemblies in the second direction according to a pre-determined pattern.

In another aspect, the method may include detecting a misalignment of the article, and in response to the detection, selectively rotating the one or more rollers of the one or more selected roller assemblies in the second direction for the selected time to substantially correct the misalignment.

In another aspect, the method may include selectively rotating the one or more rollers of the one or more selected roller assemblies in the second direction further comprises rotating the one or more rollers of the one or more selected roller assemblies at a second speed that is different from the first speed.

In another aspect, the method may include monitoring movement of the article along the conveying system for detection of one or more events. The one or more events includes passage of a first selected time during which a roller of a first selected roller assembly is rotated in the second direction, and upon detection of the passage of the first selected duration, reversing rotation of the roller of the first selected roller assembly to rotate in the first direction and reversing rotation of a roller of a second selected roller assembly to rotate in the second direction.

In another aspect, the method may include rotating the rollers of the subset of roller assemblies in the first direction comprises rotating the rollers counter-clockwise; and wherein selectively rotating the one or more rollers of the one or more selected roller assemblies in the second direction comprises rotating the one or more rollers clockwise.

In another aspect, the one or more of the subset of the plurality of roller assemblies comprise one of a rear-most positioned roller assembly, every odd number of the subset of the plurality of roller assemblies, every even number of the subset of the plurality of roller assemblies, a rear-most half of the subset of the plurality of roller assemblies, or a front-most half of the subset of the plurality of the roller assemblies.

In another aspect, the second selected duration comprises about 10 seconds to about 2 minutes.

In an additional embodiment of the disclosure, a method for heat treating an article is provided, the method comprising moving an article along a conveying system through one or more chambers of a treatment system. In embodiments, the conveying system may comprise a plurality of roller assemblies each including at least one roller along which a portion of the article is received as it is conveyed through the one or more chambers. In some aspects, the method may include rotating the rollers of a subset of roller assemblies of the plurality of roller assemblies in a first direction at a first selected speed to cause the article to be moved along a path of travel in the first direction. In addition, the method further may include, as the article is moved along the path of travel by the roller assemblies, selectively rotating one or more rollers of one or more selected roller assemblies in a second direction, slowing rotation of the one or more selected roller assemblies, stopping the one or more selected roller assemblies, or combinations thereof, for a selected time sufficient to disrupt one or more areas of frictional contact or change one or more of a magnitude or direction of a frictional force between the rollers of the one or more selected roller assemblies and the articles.

According to various aspects, the rollers of the roller assemblies can include receptables within which the article is received.

According to some aspects, the receptacles can comprise angled or slanted surfaces along which the articles can move in a direction away from an approximate center portion of one or more of the receptacles due to the frictional contact or frictional forces; and wherein when the frictional contact or frictional forces are disrupted, the article is enabled to move in a direction toward the approximately centrally aligned position within the receptacles.

Another embodiment of the disclosure is directed to a controller for controlling a conveying system. The controller may comprise a plurality of inputs/outputs in signal communication with a plurality of roller assemblies of the conveyance system. The controller may be configured to, in response to reception of an article, rotate rollers of a subset of the plurality of roller assemblies in a first direction at a first selected speed to cause the article to be moved along a path of travel in the first direction. In some embodiments, the controller may be configured to, as the article is being moved along the path of travel, selectively rotate a roller of at least one selected roller assembly in a second direction for a selected duration to disrupt one or more areas of frictional contact or change one or more of a magnitude or direction of frictional force between the article and one or more rollers of the plurality of roller assemblies sufficient to enable the article to move toward a re-aligned position with respect to a longitudinal axis extending along the conveying system.

In some embodiments, the controller can include programming (e.g., a computer program product or application) that includes the instructions for controlling the motors and further can include instructions for communication with one or more controllers for one or more roller assemblies, and/or with a facility control system.

According to an aspect, the controller may include a plurality of inputs in signal communication with a plurality of sensors each corresponding to one of the plurality of roller assemblies.

According to some further aspects, the controller may be configured to detect as misalignment of the article with respect to one or more of the roller assemblies based on data received from the plurality of sensors; and wherein the controller is configured to selectively rotate the roller of the at least one selected roller assembly in the second direction for the selected duration based on detection of misalignment.

In embodiments, the plurality of sensors may comprise one or more of proximity sensors, ultrasonic sensors, laser alignment based sensors, vibration sensors, or optical sensors.

The foregoing brief summary is provided merely for purposes of summarizing example embodiments illustrating various aspects of the present disclosure. Accordingly, it will be appreciated that the above-described embodiments are merely examples and should not be construed to narrow the scope of the present disclosure in any way. It will be appreciated that the scope of the present disclosure encompasses many potential aspects and embodiments in addition to those summarized above, some of which will be described in further detail below.

### BRIEF DESCRIPTION OF THE FIGURES

The accompanying drawings, which are included to provide a further understanding of the embodiments of the present disclosure, are incorporated in and constitute a part of this specification, illustrate embodiments of this disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced. According to common practice, the various features of the drawings discussed below are not necessarily drawn to scale. Dimensions of various features and elements in the drawings can be expanded or reduced to more clearly illustrate the embodiments of the disclosure.

FIG. 1 illustrates a schematic block diagram of a heat treatment system, according to principles of the present disclosure.

FIG. 2A, FIG. 2B, FIG. 2C, and FIG. 2D illustrate a schematic diagram of examples of a conveying system, according to principles of the present disclosure.

FIG. 3 illustrates a block diagram of a controller for a conveying system, according to principles of the present disclosure.

FIG. 4 illustrates an example flowchart for conveying an article through one or more chambers and/or other areas, according to principles of the present disclosure.

### DETAILED DESCRIPTION

The systems and methods described herein, including embodiments of treatment systems for articles, including heat treatment systems with one or more treatment chambers and conveying systems, as well as various methods of operation thereof for controlling undesired movements of an article away from a generally longitudinal axis of movement of the conveying system moving the article through a treatment chamber or between chambers, in accordance with the principles of the present disclosure, can be understood more readily by reference to the previous summary and the following detailed description, examples, drawings, and claims. However, before the present devices, systems, and/or methods are disclosed and described, it is to be understood that the present disclosure is not limited to the specific constructions, features, and/or methods disclosed unless otherwise specified, and, as such, can, of course, vary.

It is also to be understood that the terminology used herein is for the purpose of describing particular aspects only and is not intended to be limiting. Some embodiments of the present disclosure will now be described more fully hereinafter with reference to the accompanying figures, in which some, but not all, embodiments of the disclosures are shown. Indeed, these disclosures may be embodied in many different forms and should not be construed as limited to the embodiments set forth herein; rather, these embodiments are provided so that this disclosure will satisfy applicable legal requirements.

The term “controller” is used herein to refer to any one or all of one or more controllers, a supervisory controller, programmable logic controller (PLC), programmable automation controllers (PACs), a computing device, a cloud-based computing device, and/or other suitable devices.

The term “computing device” is used herein to refer to any one or all of industrial computers, desktop computers, personal data assistants (PDAs), laptop computers, tablet computers, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

As used herein, a “non-transitory machine-readable storage medium” or “memory” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. The memory may store or include instructions executable by the processor.

As used herein, a “processor” or “processing circuitry” may include, for example one processor or multiple processors included in a single device or distributed across multiple computing devices. The processor may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

As used herein, “signal communication” refers to electric communication such as hard wiring two components together or wireless communication, as understood by those skilled in the art. For example, wireless communication may be Wi-Fi®, Bluetooth®, ZigBee, or forms of near field communications. In addition, signal communication may include one or more intermediate controllers or relays disposed between elements that are in signal communication with one another.

The present disclosure is directed to enhanced systems and methods for the treatment of articles, for example, substantially round or cylindrically shaped bars or tubular articles formed from metals and metal alloys, such as steel, iron and iron alloys, aluminum, and other metal/metal alloy materials. In embodiments, the disclosure is directed to conveying systems for the transport of such articles along a path of travel through one or more chambers and/or transition spaces, and which will be configured to correct alignment of articles being conveyed thereby through one or more different chambers.

While embodiments of the systems and method of the present disclosure as shown as being used for the transport of elongated substantially round or cylindrically shaped bars or tubular articles, it will be understood by those skilled in the art that the term “article” can include a variety of other configurations and shapes of articles. For example, in embodiments, the “articles” can have configurations other generally being substantially round or cylindrical articles, and also can, in some embodiments, include tapered, solid and/or hollow articles. The articles also may include various surface features, including smooth, rough, or textured surfaces. Still further, the articles may include exterior features such as steps, dents or deformities along the surface thereof. Thus, the term “article” can include various configurations and/or shapes and is not limited solely to round or cylindrical bars/tubes/barrels. In addition, in some embodiments, articles formed from materials other than metals and/or metal alloys also can be conveyed along a path of travel using the conveying systems and methods disclosed herein.

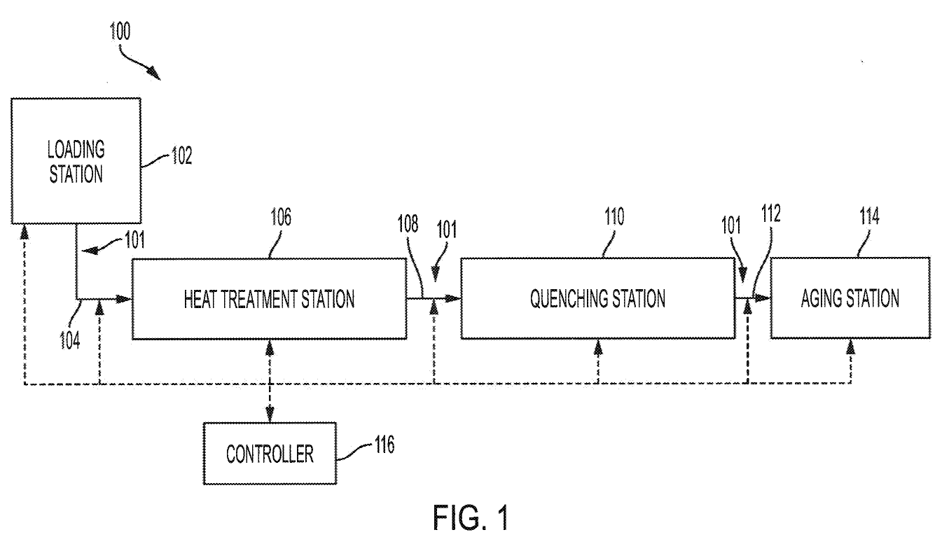

In embodiments, the systems and methods described herein are operable utilize the friction between the article and a plurality of rollers of the conveying system for moving the article along a path of travel 101 (as indicated in FIG. 1) and control of one or more selected rollers to change one or more of a magnitude and/or direction of the friction force contact between the articles and the rollers to correct alignment issues created during the conveying of the article A, without impeding current heat treatment processes.

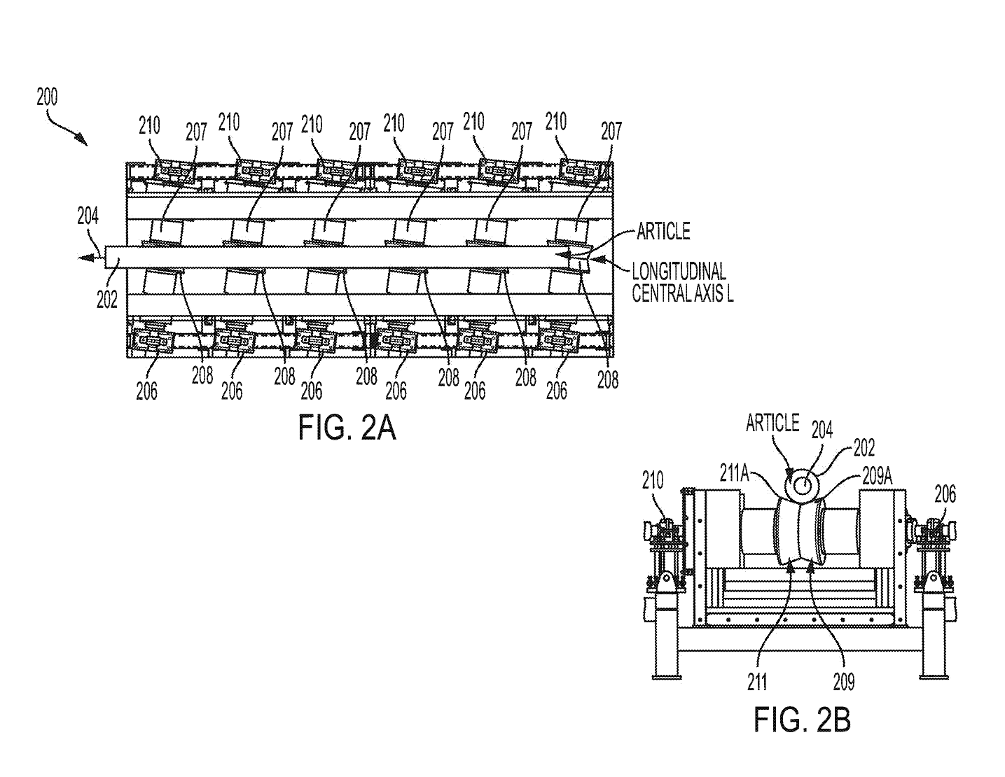

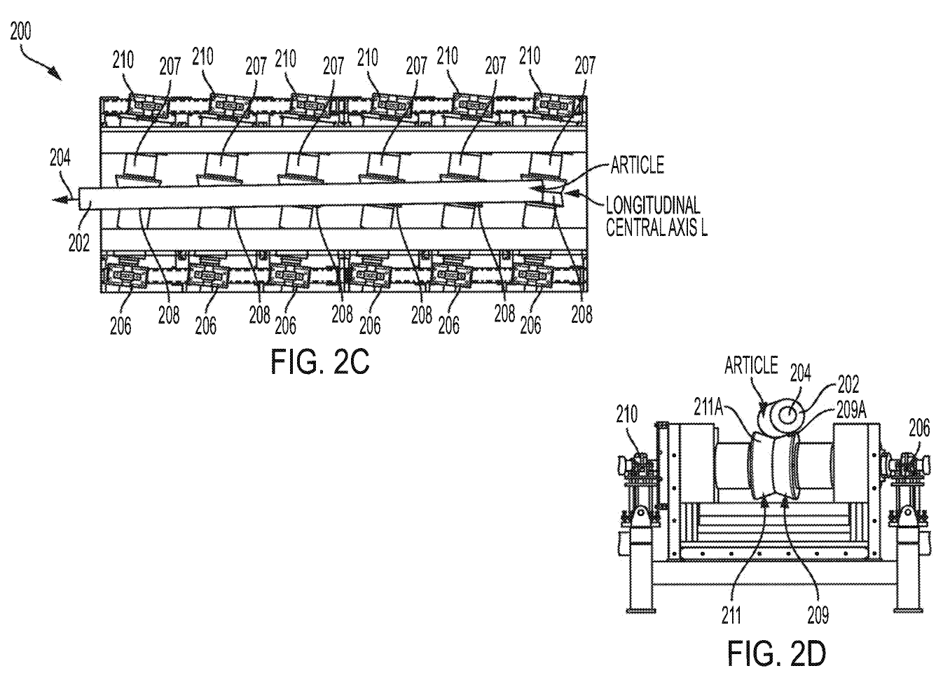

For example, as shown in FIGS. 2A-2D, in embodiments, the conveying system 200 can include a series of hourglass/butterfly rolls (other configurations also can be used), and when an article such as a generally round or cylindrically shaped pipe/tube/barrel or solid bar is run thru a treatment chamber such as a furnace (heat treatment, aging, quench or oven), the bar generally should be maintained in as straight an alignment as possible with respect to a central longitudinal central axis L extending along the path of travel of the article through the chamber or transition space and in alignment with a central portion of each roller 207. However, the friction between the bar and the surfaces of the rollers and/or fall off the hourglass roll can creep up along the sides of the rollers due to, for example, as indicated in FIGS. 2C-2D, which can cause the bar to shift or deflect from the longitudinal axis L. This can lead to warping or other deformation of the bar and inconsistent heating.

Embodiments of the present systems and methods disclosed herein are configured to selectively reverse the direction of one or more roller(s) 207 of the conveying system 200 sufficient to change one or more of the magnitude and/or direction of the friction force between the bar to the hourglass roll so it can “fall back” into the V recess of the hourglass rolls. As a result, the systems and methods are operable to generally keep the bar in a substantially straight orientation/alignment (which can reduce deflection or maybe even straighten the bar if bent before being processed), enable a more uniform heating which will results in better treatment properties of the article. In addition, keeping the article from riding up along the hourglass rolls during processing can allow for better tracking through the equipment, and prevent the bar from falling off the rollers and disrupting the treatment process.

In embodiments, such as shown in FIGS. 2A-2C, the conveying system 200 can include a plurality of roller assemblies 201 having a motor that may be selectively controlled by one or more controllers to drive its corresponding roller in an opposite direction, stop the roller, drive the roller at a different rate/speed or rotation, or combinations thereof. For example, if an article begins to track to one side or begins to misalign with a set of roller assemblies, one or more rollers of the roller assemblies can be caused to reverse direction, change speed, stop, or combinations thereof, which operation can be initiated based on a number of factors (e.g., which receptacles of the roller assemblies that the article is in contact with, a lapse of a selected duration or time, or detection of misalignment via a sensor, among other factors). The reversal in direction of the one or more selected rollers will substantially disrupt the frictional contact or change one or more of the magnitude or direction of frictional force between the rollers and the article may, causing the article to fall back or down the sides of the rollers and realign with the longitudinal axis L as shown in FIGS. 2A-2B.

Such an operation (e.g., reversal of the direction of a roller) may occur for a brief period of time or for a brief duration (for example, seconds or minutes), so as not to increase or decrease the residence time of an article in a particular chamber and since a short amount of time can cause such a frictional disruption or change in one or more of the magnitude or direction of frictional forces.

Further, in some embodiments, the direction reversal may occur based on one or more factors. Those factors may include lapse of a selected duration, detection of misalignment (for example via sensors), user input, and/or some other factor. The direction reversal may be completely automated, semi-automated, or manual.

Thus, misalignment may be corrected with limited to no user input and/or interaction. Such a correction of alignment will save time and reduce cost, since the extended period to wait for an article to cool, if such an article becomes misaligned and ultimately off-track, will not be needed due to misalignment prevention. Further, such systems and methods prevent deformation of articles due to extended periods of misalignment.

Although a high level explanation of the operations of example embodiments has been provided above, specific details regarding the configuration of such example embodiments are provided below.

FIG. 1 illustrates a schematic block diagram of a heat treatment system, according to principles of the present disclosure. FIG. 1 illustrates an example of a treatment system 100 for heat treating an article. In an embodiment, the treatment system 100 can include a series of treatment stations through which one or more conveying systems 200 (FIGS. 2A-2D) can extend. In embodiments, the conveying system(s) 200 can comprise a substantially continuous conveying system configured to extend through one or more stations of the treatment system or can include a plurality of conveying systems or sections within each station.

In embodiments, the conveying systems, and further, each roller assembly 201 thereof, may be controlled or partially controlled via a controller 116. For example, the controller 116 may control temperature, residence time, amounts of quench fluid, and/or other aspects of the system 100.

In some embodiments, such as indicated in FIG. 1, the system 100 may be configured for heat treating and other processing operations for the treatment of metal or metal alloy articles such as substantial round or cylindrical bars/tubes/barrels. For example, in some embodiments, the system 100 can include a loading station 102, a heat treatment station 106, a quenching station 110, an aging station 114, and/or transition spaces 104, 108, and 112 or transition areas. Each station may be or may include a chamber and/or, in another embodiment, may be an open area or semi-covered area. Other stations may include an oven station, a furnace, a shaping and/or forging station, and/or other station used in heat treatment and formation of articles, as will be understood by one skilled in the art.

In embodiments, a conveying system 200 (e.g., shown in FIGS. 2A-2D) may extend along a path of travel 101 through each station. In another embodiment, each station may include a different conveying system. In such embodiments, users and/or equipment may move an article from one station to another.

In an embodiment, the conveying system may be constructed to withstand high temperatures. For example, the heat treatment station 106 may reach temperatures of at least up to 2400⁰ Fahrenheit. Thus, the conveying system may withstand at least that temperature (e.g., may not deform or malfunction under such conditions).

The system 100 may convey, via the conveying system, an article therethrough. Each station may operate based on a number of factors as noted, such as a residence time (e.g., a time that the article is to reside in a corresponding station), temperature, and/or other factors for each specific station. During such residence time, the conveying system may convey the article at a selected speed and/or may halt for a period of time or for a duration.

As noted, during operation of the system 100, the surface, shape, and/or size of the article may cause the article to misalign with the roller assemblies of the conveying system. Such misalignment may include a movement in a direction perpendicular to the conveying system, causing the article to become angled. Such a misalignment can cause the article to fall off the conveying system and/or cause the article to deform. As noted, such issues cause substantial losses in time and increase cost, due to the time and effort used to resolve such issues.

FIGS. 2A, 2B, 2C, and 2D, illustrate a schematic diagram of examples of a conveying system, according to principles of the present disclosure.

The conveying system 200 may include a plurality of roller assemblies 201. In embodiments, each roller assembly 201 may include one or more rollers 207. Additional rollers may be included in the conveying system, and the numbers of roller assemblies and rollers shown in the FIGS. are only for purposes of illustration of the conveying system and not limitation.

In embodiments, such as indicated in FIGS. 2A and 2C, each of the rollers 207 may be positioned at an angle with respect to the longitudinal center axis of the conveying system 200. Such an angle may include about or approximately 0^{o} to about 20^{o}.

As further illustrated in FIGS. 2A and 2C, each of the rollers 207 may comprise an hourglass or butterfly configuration roller. The rollers further can include a body including a receptacle 208. In embodiments, the receptacles 208 can be positioned each of the rollers 207 approximately at, for example, a midpoint of each roller, in line with the longitudinal axis L of the conveying system. The receptacles also could be located at some other point along the body of each roller 207. Each of the receptacles 208 may be configured to receive an article as it is conveyed along a path of travel.

In embodiments, such as shown in FIGS. 2C-2D, each of the receptacles 208 may include a first body section 209 having a first angled side wall/surface 209A and a second body section 211 having a second angled side wall/surface 211A. Such body sections may define a V-shaped recess. The angle of each surface may comprise an angled surface extending upwardly from the body of the roller at an angle of about or approximately 5⁰ to about or approximately 30⁰. In another embodiment, the receptacles 208 may comprise a butterfly roller, an hourglass roller, or another roller with a groove or recessed middle section configured to retain an article.

Each roller assembly may include a motor or motors (e.g., such as motor 206 and/or motors 210) connected to a corresponding one of the rollers 207. For example, each roller could be connected to one motor, or in some embodiments, can be connected to a motor at each end thereof (e.g., to provide additional torque as needed for moving heavier or larger articles). Each motor (e.g., such as motor 206 and/or motors 210) may operate independently of each other motor. Each motor (e.g., such as motor 206 and/or motors 210) may connect to or be in signal communication with an individual controller or the same controller (e.g., controller 116 or controller 302).

In embodiments, each motor 206/210 may be configured to rotate the roller in at least two different directions of rotation (for example, a first and second direction, which can, in some embodiments, comprise clockwise and counter-clockwise directions), and/or at different rates/speeds. In embodiments, the plurality of motors 206 and/or motors 210 may comprise a variable frequency drive or variable speed drive motor. In addition, each motor (e.g., such as motor 206 and/or motors 210) may be bi-directional.

In an embodiment, each motor may, when a voltage is applied thereto, cause a roller to rotate in a clockwise or counterclockwise direction. The roller, based on such a rotation, may cause the article 202 to move along a path of travel 204 defined by the conveying system 200.

In addition, in some embodiments, each motor can include a motor controller (e.g., a PLC or other logic controller), and a variable frequency drive coupled to and in communication with the motor, or, is some further embodiments, integrated with the motor. Each roller can be independently directed, moved, rotated, or controlled by its motor, which, in embodiments, can receive instructions from the controller 116 as to when to change direction and/or speed, and for how long. Still further, in some embodiments, the motor controllers can include programming/instructions that can signal a change in direction and/or speed and the time/duration thereof. In some embodiments, the controller can include a computer program product or application that includes the instructions for controlling the motors, and further can include instructions for communication with one or more controllers for one or more roller assemblies, and/or with a facility control system.

FIGS. 2A and 2B illustrate movement of an article 202 along a path of travel 204 in a generally straight orientation/alignment, generally centered and in-line with the longitudinal central axis L of the conveying system 200. As the article 202 moves is moved along its path of travel by the conveying system 200 however, the article 202 may be caused to move in a lateral/diagonal direction toward an off-centered position as shown in FIGS. 2C-2B due to friction between the surface of the article 202 and the surfaces or the walls (e.g., body sections 209, 211) of the receptacles 208 of the rollers 207.

In embodiments, the rate of such a creeping or shifting movement of the article along the side walls of the receptacles can be based on the size and shape and/or weight of the article 202. In other words, as the article 202 moves forwardly along the receptacles of the conveying system, the article 202 can be rotated and urged toward a side of the conveying system such that it becomes misaligned or starts to drift or move off-track, as shown in FIGS. 2C and 2D.

In an embodiment, to realign the article 202, one or more of the motors (e.g., such as motor 206 and/or motors 210) corresponding to receptacles 208 in contact with the article 202, based on a signal received from a controller, may reverse direction. Such a reversal will cause the corresponding rollers 207 and receptacles 208 to reverse direction and pull the article 202 back into alignment based on the disruption of frictional contact between the article and a surface of the receptacle or change in one or more of the magnitude or direction of frictional force between the receptacles 208 and the article 202.

Such a reversal of motion may occur based on a number of factors. For example, the controller or controllers may be configured to transmit or send a signal to or cause the motor to reverse direction after a selected period of time or after a selected duration. In another example, the conveying system 200 may include one or more sensors to detect misalignment of the article 202.

In embodiments, the sensors may detect one or more changes in the environment or may use optical detection to determine whether the article 202 has moved off track. In such embodiments, the controller, based on signals received from the one or more sensors, may cause the direction reversal. In another embodiment, a user may interact with the motors (e.g., such as motor 206 and/or motors 210) via a user interface. The user may monitor the position of the article, for example, via a monitor that displays captured images or video of the article, and, via the user interface, cause one or more of the motors (e.g., such as motor 206 and/or motors 210) to reverse direction.

In an embodiment the article 202 may comprise a bar or billet. The bar may include a hollow or solid bar. The bar may be cylinder or tube. The bar may be tapered lengthwise. The bar may have an exterior surface or wall. The exterior wall or surface may include a substantially smooth surface, a textured or rough surface, at least one surface feature, a substantially uniform circumference, a non-uniform circumference, or combinations thereof. Misalignment may occur at higher rates based on the type of article 202. In such examples, the duration after which one or more of the motors (e.g., such as motor 206 and/or motors 210) reverse direction may change based on the type of article 202. Such information may be provided to the controller via one or more sensors and/or, via a user interface, from a user.

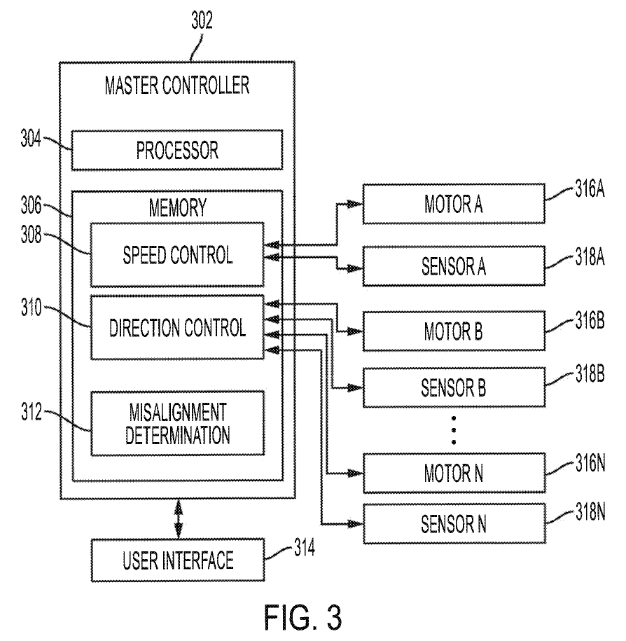

FIG. 3 illustrates a block diagram of a controller 302 for a conveying system, according to principles of the present disclosure. The controller 302 may include a processor 304 to execute instructions stored in an included memory 306. Each set of instructions may perform some function, which will be further described below. The controller 302 also may include a plurality of inputs/outputs to receive and send signals therefrom.

In embodiments, the controller 302 may be in signal communication with, via the plurality of inputs/outputs, one or more sensors 318A, 318B, and up to 318N and one or more motors 316A, 316B, and up to 316N (or, in another embodiment, a controller of each roller assembly each controller of each roller assembly being in signal communication the motors 316A, 316B, and up to 316N) and/or a user interface 314.

As noted, the controller 302 may include instructions. The instructions may include instructions 308 to control the speed of each motor 316A, 316B, and up to 316N. Such instructions 308 may determine, based on signals received from each motor 316A, 316B, and up to 316N, a current speed of each motor 316A, 316B, and up to 316N. The instructions 308 may determine what the speed of each motor 316A, 316B, and up to 316N should be based on a number of factors. For example, the memory 306 may store data indicating where each motor is located (e.g., which chamber or area).

In embodiments, for some selected areas, the controller 302 may increase speed of the motors 316A, 316B, and up to 316N (e.g., at a transition between, for example, the heat treatment and quench chambers), while at other locations, the controller 302 may determine that speed of the motors 316A, 316B, and up to 316N should be decreased (e.g., within the heat treatment chamber, based on temperature and the type of article being heated).

In another embodiment, the controller 302 may determine a change in speed based on a reversal of direction. For example, as the direction of a motor 316A, 316B, and up to 316N is reversed, the speed may increase to cause the article to realign. After realignment, the controller 302 may adjust the speed of the motors 316A, 316B, and up to 316N to a previous setting or speed.

In an embodiment, the motors 316A, 316B, and up to 316N may operate at a steady speed. In yet another embodiment, the motors 316A, 316B, and up to 316N may operate at a steady speed regardless of direction or area. In another embodiment, the instructions 308 may determine that the motors 316A, 316B, and up to 316N should cease operation due to, for example, a selected residence time and/or due to some other factor.

The controller 302 may include instructions 310 to control direction of each motor 316A, 316B, and up to 316N. In embodiments, such instructions 310 may cause directional change for some of the motors 316A, 316B, and up to 316N after a selected duration or time. In another embodiment, the controller 302 may determine a directional change based on misalignment determination or detection (as described for instructions 312). Such a directional change may occur for a time or duration less than the time or duration that the motors 316A, 316B, and up to 316N are in the original direction.

Further, the controller 302 may determine which of the motors 316A, 316B, and up to 316N to engage to cause reversal of a selected roller(s). In an embodiment, choosing one of the motors 316A, 316B, and up to 316N may be arbitrary (for example, the last motor may switch direction, a directional change may be staggered for each of the motors, and/or some other combination of motors may be utilized). In another embodiment, the motors 316A, 316B, and up to 316N chosen may be based on which receptacle of a roller assembly that the article is in contact with.

In yet another embodiment, the one or more sensors 318A, 318B, and up to 318N may be utilized to determine which motors 316A, 316B, and up to 316N would be the most optimal to realign the article.

The controller 302 may include instructions 312 to determine misalignment. The instructions 312 may utilize data from the one or more sensors 318A, 318B, and up to 318N to determine whether an article has become misaligned. For example, the sensors 318A, 318B, and up to 318N may include an optical sensor. Based on a change in object detection, the controller 302, via the instructions 312, may determine that the article has become misaligned.

In another embodiment, the sensors 318A, 318B, and up to 318N may include a temperature sensor and based on temperature fluctuations, the controller 302 may determine that the article has moved. Other sensors may be utilized to determine misalignment, such as proximity sensors, ultrasonic sensors, laser alignment based sensors, vibration sensors, and/or optical sensors. In another embodiment, misalignment may be determined based on input from a user via the user interface 314.

In still a further embodiment, as noted above, each motor can include a motor controller (e.g., a PLC or other logic controller), and a variable frequency drive in communication therewith and which can include programming/instructions that can control a change in direction and/or speed and the time/duration of change. In embodiments, the motor controllers can operate without direct control bv the controller 302 (e.g., without the controller signaling each motor individually when to change direction/speed and/or for how long), with each motor reversing its roller (and in some embodiments, changing its speed) for a selected time according to a pre-selected sequence of operation.

In embodiments, during a method of operating the system 100, and further the conveying system 200 for changing one or more of the magnitude and/or direction of the friction force or contact between the article and one or more rollers, and, in some embodiments, maintaining a desired alignment of, for example, an article such as a substantially round bar/tube/barrel may contact only 2-3 rollers at a time (though sometimes it may contact more rollers). In general, in some aspects of the method, the reversing of the rollers can be done on a systematic basis.

For example, in embodiments, the system can operate wherein a roller # 1 reverses and rotates in the second direction (e.g., clockwise) for a selected time (e.g., 1-30 seconds, or in some embodiments, longer, e.g., 1 minute or more as needed) while all other rollers continue to be driven is the first direction (e.g., counter-clockwise) to continue driving the article in a forward direction along the path of travel thereof. After the time of the counter direction rotation of roller #1 has expired, roller # 2 can reverse with all other rolls (including roll #1 goes forward). After the time of the counter direction rotation of roller #2 has expired, roller #3 reverses with all other rolls including rollers #1 and #2 go forward). This pattern can continue until it reaches the last roller of the equipment, and then pattern returns and repeats from roller #1.

Other patterns also can be used. For example, and without limitation, in embodiments, an odd or even roller pattern where roller 1, then roller 3, then roller 5, etc. are reversed while the even rollers 2, 4, 6, etc.. rotate in the first direction without being reversed. In other embodiments, multiple rollers can be rotated in the second/reverse direction at a time.

Alternatively, in some embodiments, individual ones of the rollers can be reversed on a selected basis. For example, with the controller 116 selectively controlling one or more rollers at selected locations along the conveying system. The controller can control selected rollers by signaling the motors thereof to reverse based on a selected timing, or in response to signals from one or more sensors detecting a misalignment. The selection of the rollers also could be based on a size, configuration and/or weight of the article.

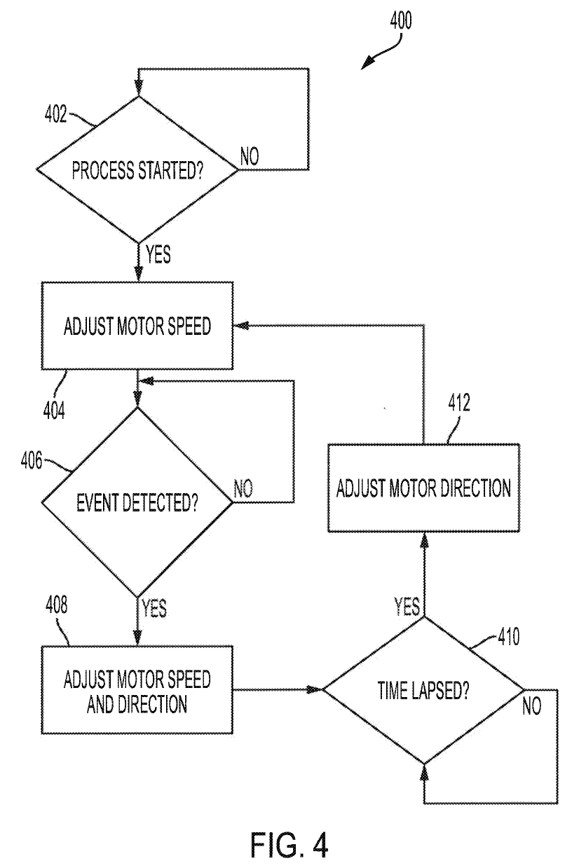

FIG. 4 illustrates an example flowchart 400 for conveying an article through one or more chambers and/or other areas, according to principles of the present disclosure. It will be understood that each flowchart block, and each combination of flowchart blocks, may be implemented by various means, embodied as components, equipment, hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus.

As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device, controller, or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

At block 402, the system may determine whether the process for one or more chambers has started. Such a determination may occur based on user input and/or based on some condition (e.g., an article entering a selected chamber or area). At block 404, the system may adjust the speed of a selected one or more motors to begin conveying an article along a path of travel. The speed may be related to the particular or selected chamber associated with those motors and/or the type of article.

At block 406, the system may determine whether an event has been detected. Such an event may include detection of misalignment, lapse of a time or duration, and/or an input by a user. If no event has been detected, then the motors will remain the same speed and direction as previously determined to continue conveyance of the article along the path of travel. If an even has been detected, then, at block 408, the system may adjust motor speed and direction. The system may select one or more different motors to adjust based on the number of roller assemblies in contact with the article.

The motor speed and direction may be set for a selected period of time or duration. At block 410, if the time or duration has lapsed, then the system, at block 412, may readjust the motor direction and, in embodiments, may readjust the motor speed, as indicated at block 404.

The flowchart blocks support various embodiments and combinations of systems and/or features or components thereof for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present disclosure.

What is claimed is:

1. A system, comprising:
a chamber;
at least one conveying system extending through the chamber and configured for conveying an article to be treated along a path of travel through the chamber:
wherein the at least one conveying system comprises a plurality of roller assemblies, each of the plurality of roller assemblies including:
at least one roller,
a receptacle defined along the at least one roller and configured to receive the article therein as the article is conveyed along the path of travel, and
at least one motor coupled to the at least one roller and configured to rotate the at least one roller in a first direction for moving the article along the path of travel through the chamber, and a second direction that is opposite the first direction; and
wherein as the article is moved along the path of travel through the chamber, one or more selected rollers of one or more roller assemblies are driven in the second direction for a time sufficient to disrupt frictional contact or change one or more of a magnitude or direction of a frictional force between at least a portion of the article and the one or more selected rollers so as to substantially maintain an alignment of the article within the receptacles of the roller assemblies.

2. The system of claim 1, further comprising at least one controller in communication with the roller assembles and including programming configured to operate one or more motors of a series of the roller assemblies to drive the rollers thereof in the first direction at a speed and for a selected duration to cause the article to be moved along the path of travel, and to selectively operate the one or more motors to drive the one or more selected rollers in the second direction.

3. The system of claim 2, wherein the at least one controller further comprises programming configured to operate one or more motors of the plurality of roller assemblies to cause the one or more selected rollers at a different speed and for a duration less than the selected duration to drive the one or more selected rollers in the second direction sufficient to disrupt the frictional contact or change the one or more of the magnitude or direction of frictional force created between the article and the receptacles of the roller assemblies and cause the article to move toward a re-aligned position within the receptacles.

4. The system of claim 1, wherein each roller assembly further includes a controller coupled to the motor and including programming configured to operate its motor to drive the at least one roller coupled to the motor in the first direction for a first selected time period, and after the first selected time period, drive the roller in the second direction for a second selected time period; wherein the second selected time period is less than the first selected time period.

5. The system of claim 4, wherein each controller is further configured to operate its motor so as to drive the at least one roller coupled to the motor in the first direction at a first speed and drive the at least one roller coupled to the motor in the second direction at a second speed that is different from the first speed.

6. The system of claim 1, wherein the chamber comprises one or more of a furnace, an air quench, a water quench, an oven, or a transition space.

7. The system of claim 1, wherein the article comprises a bar having a substantially solid or a substantially hollow construction.

8. The system of claim 7, wherein the bar further comprises an exterior wall; and wherein the exterior wall comprises a substantially smooth surface, a textured or rough surface, at least one surface feature, a substantially uniform circumference, a non-uniform circumference, or combinations thereof.

9. The system of claim 1, wherein each receptacle includes a body having a first surface extending at an angle away from a center portion of the body and a second body section having a second surface extending at an angle away from the center portion in an opposite direction from the first surface so as to define a substantially V-shaped recess configured to receive the article therein.

10. The system of claim 9, wherein the first surface and the second surface extend upwardly at an angle of between approximately 5° to approximately 30°.

11. The system of claim 1, wherein the at least one roller of each roller assembly is arranged at an angle of between approximately 0° to approximately 20° with respect to a longitudinal axis of the at least one conveying system.

12. The system of claim 1, wherein each motor comprises a variable speed drive motor or a variable frequency drive motor.

13. The system of claim 1, wherein each roller comprises a substantially hourglass-shaped configuration including a pair of opposed angled surfaces defining the receptacles.

14. The system of claim 1, wherein the roller assemblies each comprise a temperature rating of up to 2400^{o} Fahrenheit.

15. A conveying system comprising:
a plurality of roller assemblies, each of the plurality of roller assemblies including:
a roller,
a receptacle defined along the roller and configured to receive an article therein as the article is conveyed along a path of travel, and
at least one motor coupled to the roller and configured to rotate the roller in a first direction for moving the article along the path of travel, and a second direction that is opposite the first direction; and
wherein as the article is moved along the path of travel, one or more selected rollers of one or more roller assemblies are driven in the second direction for a selected time sufficient to disrupt frictional contact or change one or more of a magnitude or direction of frictional force between at least a portion of the article and at least some of the rollers of the roller assemblies so as to substantially maintain an alignment of the article within the receptacles as the article moves along its path of travel.

16. The system of claim 15, further comprising at least one sensor located along the path of travel of the article and configured to detect misalignment of the article; and wherein in response to detection of the misalignment of the article by the sensor, the one or more selected rollers are driven in the second direction for the selected time.

17. The system of claim 15, further comprising a controller in communication with the plurality of roller assemblies and comprising a processor and a memory configured to store instructions, that, when executed by the processor, operate the motors of a series of the roller assemblies to drive the rollers thereof in the first direction at a first speed for moving the article along the path of travel, and to selectively operate one or more motors to drive the one or more selected rollers in the second direction for the selected time.

18. The system of claim 17, wherein each receptacle comprises a pair of opposite angled surfaces defining a substantially V-shaped recess configured to receive the article therein; and wherein the controller further includes configured to operate the one or more motors to drive the one or more selected rollers in the second direction at a second speed that is different from the first speed.

19. The system of claim 15, wherein the conveying system extends through one or more of a furnace, an air quench, a water quench, an oven, or a transition space.

20. The system of claim 15, wherein the article comprises an article having a substantially solid or hollow construction; and wherein the article includes a substantially smooth surface, a textured or rough surface, at least one surface feature, a substantially uniform circumference, a non-uniform circumference, or combinations thereof.

21. A method comprising:
positioning an article along a conveying system;
wherein the conveying system comprises:
a plurality of roller assemblies each including at least one roller having a receptacle located therealong and within which a portion of the article is received;
with the article received within the receptacles of the roller assemblies, rotating the rollers of a subset of roller assemblies of the plurality of roller assemblies in a first direction and at a first speed to move the article in the first direction along a path of travel; and
as the article is moved along the path of travel in the first direction, rotating the rollers of one or more selected roller assemblies in a second direction for a selected time sufficient to disrupt frictional contact or change one or more of a magnitude or direction of frictional force between the article and one or more rollers of the plurality of roller assemblies so as to maintain the article in a substantially centrally aligned position with respect to a longitudinal axis of the conveying system.

22. The method of claim 21, wherein selectively rotating the rollers of the one or more selected roller assemblies in the second direction comprises sequentially rotating the rollers of successive ones of the roller assemblies in the second direction according to a pre-determined pattern.

23. The method of claim 21, further comprising detecting a misalignment of the article, and in response to the detection, selectively rotating the rollers of the one or more selected roller assemblies in the second direction for the selected time to enable the article to move toward the centrally aligned position to substantially correct the misalignment.

24. The method of claim 21, wherein selectively rotating the rollers of the one or more selected roller assemblies in the second direction further comprises rotating the rollers at a second speed that is different from the first speed.

25. The method of claim 21, further comprising monitoring movement of the article along the conveying system for detection of one or more events.

26. The method of claim 25, wherein the one or more events includes passage of a first selected time during which the at least one roller of a first selected roller assembly is rotated in the second direction, and upon detection of the passage of the first selected time, reversing rotation of the at least one roller of the first selected roller assembly to rotate in the first direction and reversing rotation of the at least one roller of a second selected roller assembly to rotate in the second direction.

27. The method of claim 22, wherein rotating the rollers of the subset of roller assemblies in the first direction comprises rotating the rollers counter-clockwise; and wherein selectively rotating the rollers of the one or more selected roller assemblies in the second direction comprises rotating the rollers of the one or more selected roller assemblies clockwise.

28. The method of claim 22, wherein the rollers of the subset of roller assemblies comprise one or more of a rear-most positioned roller assembly, one or more odd number roller assemblies, one or more even number roller assemblies, a rear-most half of the roller assemblies, or a front-most half of the roller assemblies.

29. The method of claim 22, wherein the selected time comprises about 10 seconds to about 2 minutes.

30. A controller for controlling a conveyance system of an article treatment system, the controller comprising:
a plurality of inputs/outputs in signal communication with a plurality of roller assemblies of the conveyance system, the controller configured to:
in response to reception of an article, rotate rollers of a subset of the plurality of roller assemblies in a first direction at a first selected speed to cause the article to be moved along a path of travel in the first direction; and
as the article moves along the path of travel, selectively rotate the roller of at least one selected roller assembly in a second direction for a selected duration sufficient to substantially disrupt frictional contact or change one or more of a magnitude or direction of frictional force between the article and one or more rollers of the plurality of roller assemblies so as to cause the article to move toward a position substantially aligned with a longitudinal axis of the conveying system.

31. The controller of claim 30, further comprising a plurality of inputs in signal communication with a plurality of sensors each corresponding to one of the plurality of roller assemblies.

32. The controller of claim 31, wherein the controller is configured to detect a misalignment of the article based on data received from the plurality of sensors and selectively rotate the roller of the at least one selected roller assembly in the second direction for the selected duration based on detection of misalignment.

33. The controller of claim 31, wherein the plurality of sensors comprise one or more of proximity sensors, ultrasonic sensors, laser alignment based sensors, vibration sensors, or optical sensors.
